(19) United States
(12) Patent Application Publication
(10) Pub. No.: US 2008/0047327 A1
(43) Pub. Date: Feb. 28, 2008

(54) RHEOMETER

(76) Inventor: Reinhard Uphus, Hannover (DE)

Correspondence Address: ROBERT W. BECKER & ASSOCIATES, 707 HIGHWAY 333, SUITE B, TIJERAS, NM, 87059-7507, US

(21) Appl. No.: 11/828,138

(22) Filed: Jul. 25, 2007

(30) Foreign Application Priority Data
Jul. 25, 2006 (DE) 10 2006 034 390.5

(51) Int. Cl. G01N 11/00

(52) U.S. Cl. 73/54.11

(57) ABSTRACT

A rheometer for measuring the viscosity of a fluid, and comprising an extruder by means of which the rheometer can be filled with the fluid; the rotation speed of the extruder can be adjusted for the filling of the rheometer.

The instant application should be granted the priority dates of Jul. 25, 2006, the filing date of the corresponding German patent application 10 2006 034 390.5.

### BACKGROUND OF THE INVENTION

The invention relates to a rheometer, which serves for measuring the viscosity of a fluid.

The fluids to be measured here include, for example, rubber mixtures and polymer melts. For polymer melts, for example, rotary viscometers on the couette principle or on the taper plate principle may be used, the last-mentioned principle having the advantage that the shear rate is constant independently of the radius.

Rotary viscometers of this type have in common the fact that a rotating body is driven with a predetermined motive force, and the resistance with which the fluid opposes the rotation is measured. As a result, the shear resistance of the fluid and, consequently, the viscosity can be determined.

A precondition for correct measurement is that the fluid does not come loose from the wall of the rheometer. The rotary body should, in that respect, not “spin”.

In order to prevent spinning, it became known to configure the wall of the rotary body with profiled surfaces, as is the case in Mooney viscometers. This solution has proved appropriate in practice, the implementation of the internal corners there having some disadvantages. When the composition of the fluid is changed, residues of the previous fluid typically remain in the internal corners, so that contamination occurs.

Even in rheometers with profiled surfaces, highly viscous and highly elastic mixtures may slide along the wall. Typically, the viscosity is measured at a predetermined temperature, for example 100° C., and a corresponding blank is introduced which is heated. To balance the temperature, a waiting time of, for example, 1 minute is built into the calculation, although temperature compensation is usually incomplete) since polymers are exceptionally poor conductors of heat.

The operation of the rheometer, on the other hand, gives rise typically to a further temperature increase and shearing action subjecting the material to stress. In that respect, temperature compensation can be usually carried out only after an exceptionally long waiting time.

It has also already become known to connect rheometers on the outlet side of an extruder. An example of a solution of this type may be gathered from DE 33 24 842. In this solution, discontinuities in the fluid stream are to be avoided by means of a specially formed torsion tube with an annular gap. On the other hand, this design is highly complicated, but, even so, highly viscous fluids may come loose from the wall.

The object on which the invention is based, therefore, is to provide a rheometer of the aforementioned general type which has a large measuring range, that is to say is suitable even for highly viscous materials, although there is to be the possibility of carrying out continuous measurements.

### SUMMARY OF THE INVENTION

This object is achieved according to the invention, by means of a rheometer comprising an extruder by means of which the rheometer can be filled with fluid, wherein the rotational speed of the extruder can be adjusted for the filling of the rheometer.

According to the invention, there is provision for the rheometer to be filled by the extruder worm in a directed manner as a function of the material or of the internal pressure of the material. By the material stream filling the rheometer being capable of being set, surprisingly, the tendency of highly viscous fluids to come loose from the wall can be compensated. Where highly viscous fluids are concerned, a higher pressure arises during corresponding volumetric conveyance. Owing to the increase in pressure, the tendency to slide along the wall of the rheometer can be reduced.

On the other hand, an extruder, for example a typical worm extruder, is not a volumetric conveyor. Accordingly, according to the invention, there is provision, for the purpose mentioned, for the rotational speed of an extruder to be increased or, in general, to be made capable of being set, such that the internal pressure of the rheometer is optimized as a function of the measured fluid.

It is particularly beneficial, in this respect, if a pressure sensor detects the internal pressure of the fluid and the rotational speed of the extruder is set as a function of this,

According to the invention, in a beneficial refinement, the heating in the region of the measurement chamber of the rheometer is also detected. Increasing internal fritin gives rise to increasing heating. By the rotational speed of the extruder worm being reduced, the mass temperature can preferably be brought to the desired temperature, the pressure in the measurement chamber being capable of being set within wide ranges via the drive for the extruder.

The invention makes it possible to implement a closed system, that is to say one in which the outlet orifice of the measurement chamber is closed when the measurement chamber is filled completely, but also to implement an open system. In the second case, the wideslot nozzle of the extruder serves as flow resistance, counter to which a pressure is built up.

Surprisingly, according to the invention, wall slip can be avoided completely by the rise in pressure. According to the invention, for this purpose, a particularly high mass pressure is provided by the extruder, thus resulting, with respect to the wall, in a particularly high frictional resistance which prevents any breakaway there,

A further advantage according to the invention is also the reduction in the analysis time, precisely even where highly viscous and elastic polymer melts and rubber mixtures are concerned. The pressure rise allows a good intermixing to reduce the temperature differences, so that the measurement time can be reduced significantly.

### BRIEF DESCRIPTION OF THE DRAWINGS

Further advantages, details and features may be gathered from the following description of an exemplary embodiment, with reference to the drawings in which,

FIG. 1 shows a diagrammatic view of an extruder with a rheometer according to the invention; and

FIG. 2 shows a sectional view of a detail from FIG. 1.

### DESCRIPTION OF SPECIFIC EMBODIMENTS

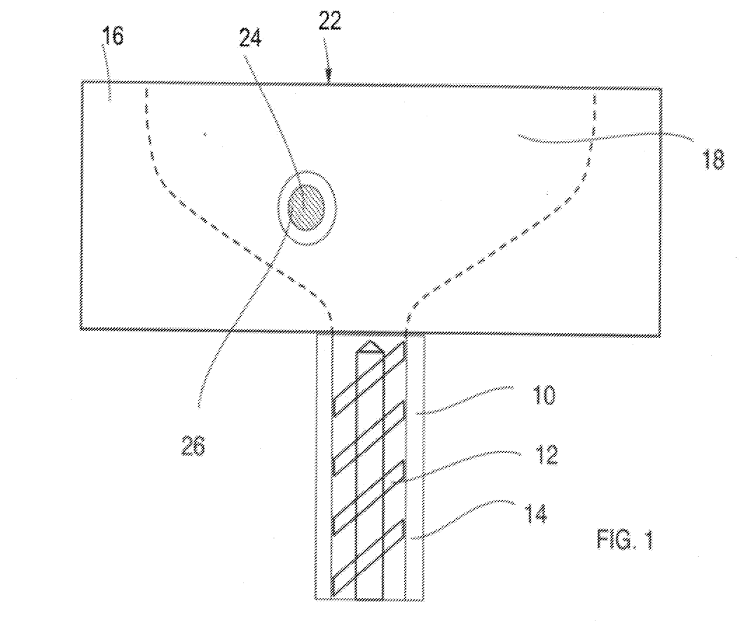

FIG. 1 shows an extruder 10 which supports an extruder worm 12 rotatably in an extruder housing 14. The extruder worm 12 can be driven via an extruder motor, not illustrated. Its rotational speed corresponds essentially to the rate of conveyance of the mass extruded by the extruder, although there is no exact proportionality.

The extruder 10 has, following the extruder worm 12, an extruder nozzle 16. There, a flow duct 18 is formed, which serves for shaping the circular flow in the region of the extruder worm into a flat-rectangular flow.

In the exemplary embodiment illustrated, the extruder nozzle 16 has a nozzle slot 22. The nozzle slot 22 is narrowed with respect to the flow duct 18 and in that respect forms flow resistance for the mass which flows in the flow duct 18.

According to the invention, a rheometer 24 is provided which extends away from the flow duct 18. In flow terms, the rheometer 24 is, in that respect, arranged between the extruder worm 12 and the nozzle slot 22. The rheometer 24 is designed as a rotar viscometer and operates on the couette principle. It has a rotar body 26 which is driven in a way known per se and, during its rotation, subjects the mass received in the rheometer 24 to shearing or thrust stress. The viscosity, in that respect, arises from the rotational resistance of the rotary body 26.

According to the invention, to fill the rheometer 24, the rotational speed of the extruder worm 12 can be set. Where a highly viscous mass is concerned, the extruder worm 12 operates counter to a comparatively high internal pressure, whereas, with regard to a virtually liquid mass, the internal pressure is correspondingly low. Even for different viscosities, the desired temperature for measurement can be reached quickly and in a flexible way by the setting of the rotational speed of the extruder worm.

Moreover, owing to the pressure rise in the cape of highly viscous masses, the risk of their sliding along the wall in the rheometer 24 is eliminated. According to the invention, the internal pressure in the rheometer 24 is such that sliding does not occur.

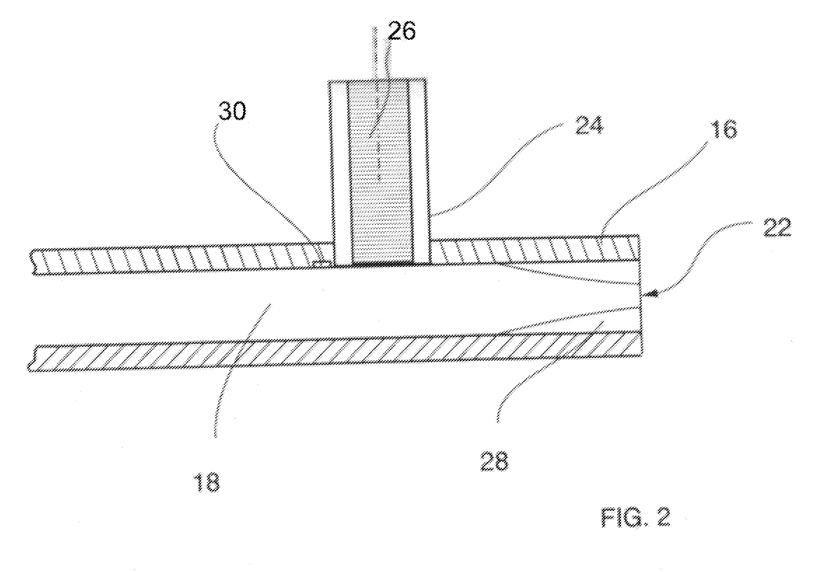

A sectional view of the rheometer 24 can be seen from FIG. 2. As is evident from FIG. 2, the nozzle slot 22 is formed by nozzle bodies 28 which make it possible to have the desired diameter reduction. The rheometer 24 is flow-connected to the flow duct 18, the pressure, but preferably both the pressure and the temperature, of the mass being measured in the immediate vicinity of said rheometer via a sensor 30S This—affords the possibility of further optimizing the rotational speed of the extruder worm for filling the rheometer.

In a modified refinement, the nozzle slot 22 is closed completely. In this solution, the extruder worm 12 serves solely for filling the rheometer 24, but continuous measurement is not possible, in contrast to the embodiments illustrated in the figures,

In any event, the rheometer 24 is provided in a way known per se with an overflow orifice which makes it possible to discharge the air emerging from the rheometer and which can be closed in a way known per se.

The specification incorporates by reference the disclosure of German priority document 10 2006 034 390,5 filed Jul. 25, 2006

The present invention is, of course, in no way restricted to the specific disclosure of the specification and drawings, but also encompasses any modifications within the scope of the appended claims.

I claim:

1. A rheometer for measuring the viscosity of a fluid, comprising:
an extruder (10), wherein the rheometer (24) is adapted to be filled with the fluid by the extruder (10), and wherein a rotational speed of the extruder (10) is adjustable for the filling of the rheometer (24).

2. A rheometer according to claim 1, wherein the rheometer (24) is connected to an outlet side of an extruder worm (12) of the extruder (10) and upstream of an extruder nozzle (16).

3. A rheometer according to claim 1, wherein the extruder (10) is provided with an extruder nozzle (16) for tiling of the rheometer (24), and wherein the extruder nozzle (16) is adapted to be closed.

4. A rheometer according to claim 1, wherein a pressure sensor (30) is disposed in the region of the rheometer (24), and wherein the rotational speed of the extruder (10) is adapted to a desired pressure.

5. A rheometer according to claim 1, wherein a side stream of the fluid is adapted to be conducted through the rheometer (24).

6. A rheometer according to claim 1, wherein the rheometer (24) is adapted to continuously measure the viscosity of the liquid.

7. A rheometer according to claim 1, wherein an evaluation circuit is connected to the rheometer (24).

8. A rheometer according to claim 7, wherein the evaluation circuit is also connected to a pressure sensor.

9. A rheometer according to claim 8, wherein the evaluation circuit is further connected to at least one temperature sensor.

10. A rheometer according to claim 8, wherein the viscosity of the fluid is adapted to be detected by the pressure sensor in comparison with the pressure at the rheometer (24).

11. A rheometer according to claim 9, wherein the viscosity of the fluid is adapted to be detected by the pressure sensor and by the at least one temperature sensor in comparison with the pressure at the rheometer (24) and also with the temperature.

12. A rheometer according to claim 1, wherein the extruder (10) is provided with an extruder nozzle (16) at which extruded fluid can be observed and visually judged.

13. A rheometer according to claim 12, wherein the extruder nozzle (16) is a flat nozzle.

14. A rheometer according to claim 1, wherein the rheometer (24) is embodied as an oscillating viscometer,

15. A rheometer according to claim 1, wherein the rheometer (24) is embodied as a rotating viscometer.

16. A rheometer according to claim 15, wherein the rotating viscometer has a superimposed oscillation.

17. A rheometer according to claim 1, wherein a mass pressure of the fluid in the rheometer (24) is adapted to be set at more than 30 bar.

18. A rheometer according to claim 17, wherein a mass pressure of the fluid in the rheometer (24) is adapted to be set at approximately 100 bar.

19. A rheometer according to claim 1, wherein the rheometer (24) has an unprofiled wall surface, and wherein the fluid is adapted to adhere to the wall of the rheometer (24) during a measurement process.
